(19) United States
(12) Patent Application Publication
(10) Pub. No.: US 2008/0181672 A1
(43) Pub. Date: Jul. 31, 2008

(54) DEVELOPMENT APPARATUS AND IMAGE FORMING APPARATUS

(75) Inventors: Takashi Hatakeyama, Kanagawa-ken (JP); Minoru Yoshida, Tokyo (JP); Takao Izumi, Kanagawa-ken (JP); Hiroshi Murata, Kanagawa-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/966,315

(22) Filed: Dec. 28, 2007

Related U.S. Application Data
(60) Provisional application No. 60/886,575, filed on Jan. 25, 2007.

(30) Foreign Application Priority Data
Jul. 5, 2007 (JP) 2007-177734

(51) Int. Cl. G03G 15/08

(52) U.S. Cl. 399/254

(57) ABSTRACT

There is provided a development apparatus which enables stable agitation and discharge of a developer from a developer discharge port, and an image forming apparatus including this development apparatus. The development apparatus which supplies the developer to a development roller and conveys the developer while agitating it, includes a developer path including a first path and a second path whose height is lower than the first path and which is continuous with the first path in a conveyance direction of the developer, and a conveying member which is provided in the developer path, includes a rotary shaft along the conveyance direction and a rotary blade spirally provided along an outer periphery of the rotary shaft, conveys the developer in the conveyance direction by rotating the rotary blade around the rotary shaft, and includes a first section which is a section overlapping with the first path and in which the rotary blade has a specified conveyance characteristic in the conveyance direction, and a second section which is a section overlapping with the second path in the conveyance direction and in which the conveyance characteristic of the rotary blade is different from that in the first section.

### BACKGROUND OF THE INVENTION

1. Field of the Invention

The present invention relates to a development apparatus to develop an electrostatic latent image formed on a photoconductive body into a toner image in an image forming apparatus such as an electrophotographic copying machine or a laser printer, and the image forming apparatus.

2. Description of the Related Art

Hitherto, there is a development apparatus to develop an electrostatic latent image formed on a surface of an image bearing body (photoconductive body) with a two-component developer including a toner and a carrier. In the development apparatus as stated above, in a development container containing the two-component developer, the toner is consumed by image formation, whereas the carrier is not consumed but remains in the development container. In the remaining carrier, the resin coating material of the surface of the carrier is peeled by the repetition of image formation and the toner component is attached to the surface of the carrier. This phenomenon reduces the charging performance of the developer, causes fogging, uneven density or the like due to the poor charging of the toner, and causes degradation in picture quality.

For the purpose of suppressing the deterioration of the developer, there is proposed a system in which a developer made of a mixture of a carrier and a toner is supplied into a development container, or a carrier and a toner are separately supplied into a development container. Here, although the toner is consumed by image formation, since the carrier remains in the development container, when the toner concentration of the developer is kept constant, the developer in the development container is increased. Thus, in order to decrease the surplus developer in the development container, the developer is discharged by overflow through a developer discharge port provided on the wall surface of the development container. The system as stated above is called a trickle system, and since the developer deteriorating in the development container is replaced with a newly supplied toner and carrier, the charging performance of the developer is kept and the degradation in picture quality can be suppressed.

In a system in which a new developer is supplied as in the trickle system, when only agitation is performed for the purpose of charging the developer, the toner concentration in the vicinity of a supply port becomes high. Then, in the development apparatus to supply the developer as in the trickle system, there are many proposals in which the developer in the container is conveyed while being agitated. For example, there is a development apparatus in which a developer conveying member including a rotary shaft and a rotary blade spirally formed along the outer periphery of the rotary shaft is disposed in a developer conveying path of the development apparatus, and the agitation and conveyance of the developer is performed by the rotation of the developer conveying member. In the development apparatus as stated above, a development roller and the developer conveying member are disposed to be close to each other in order to supply the developer to the development roller. Besides, since the development roller is attached by a clamp or the like to the development container, the development container has such a shape that the upper surface of the developer conveying path is protruded downward to provide a hollow on the upper surface, and the clamp or the like can be contained in the hollow. Alternatively, seal members are disposed at both ends of the development roller so that the developer does not leak.

Besides, in the development apparatus using the trickle system, it is desired that not only the agitation and conveyance of the developer is performed, but also the amount of developer in the development container is kept within a suitable range. When the amount of developer is excessively increased, sufficient agitation is not performed, so that the charging performance is reduced and uneven density or fogging occurs. On the other hand, when the amount of developer is excessively decreased, the supply of the developer to the development roller becomes insufficient, and an image defect such as uneven density or a white patch occurs.

Against this problem, in order to keep the amount of developer within a suitable range, there is proposed a development apparatus in which a developer conveying member including a rotary shaft and a rotary blade spirally formed along the outer periphery of the rotary shaft is disposed in a developer conveying path of the development apparatus, a developer discharge port is provided on the wall surface of the developer conveying path, and in the developer conveying member, the outer diameter of the rotary blade in a portion corresponding to a region where the developer discharge port is disposed is made small, or a pitch thereof is made small (for example, JP-A-2000-81787). In this development apparatus, the outer diameter of the rotary blade of the developer conveying member is made small or the pitch thereof is made narrow, so that the conveying amount of the developer is made smaller than that in a normal portion (for example, a portion other than the vicinity of the developer discharge port), and the developer is locally raised.

In the related art development apparatus, in the portion where the clamp, the seal member and the like are disposed, the upper surface of the developer conveying path protrudes downward, and accordingly, the developer conveying path is narrowed, that is, the height from the bottom is low. Accordingly, especially in the case where the upper surface (protrusion) of the narrow portion (narrowed part) more protrudes toward the developer conveying path side than the development roller, there is a problem that the developer conveyed by the developer conveying member is liable to be clogged in the narrowed part, the clogged developer overflows toward the development roller side, and uneven density occurs.

Besides, as in the development apparatus in which the developer is locally raised, in the case where the developer discharge port is provided in the upper part of the container wall surface at the downstream side of the narrowed part in order to stably discharge the developer from the developer discharge port, there is a case where a following problem arises. For example, in the case where the shape of the developer conveying path is such that it is narrowed at the inlet of the narrowed part and is widened at the outlet, the upstream side skirt of the developer raised in the region of the developer discharge port comes in contact with the protrusion, and blocks the space at the exit of the narrowed part. Accordingly, the developer is clogged in the narrowed part, and as a result, the developer is clogged also in the protrusion at the inlet of the narrowed part. Alternatively, the upstream side skirt of the interface of the raised developer comes in contact with the protrusion, and when the developer goes out of the narrowed part, the compressed developer is blown off, the interface of the developer in the downstream region is swayed, and stable discharge from the developer discharge port can not be performed.

### SUMMARY OF THE INVENTION

It is an object of an embodiment of the invention to provide a development apparatus which enables stable agitation and discharge of a developer from a developer discharge port, and an image forming apparatus including this development apparatus.

In order to solve the above problem, according to an aspect of the invention, a development apparatus which supplies a developer to a development roller and conveys the developer while agitating it, includes a developer path including a first path and a second path whose height is lower than the first path and which is continuous with the first path in a conveyance direction of the developer, and a conveying member which is provided in the developer path, includes a rotary shaft along the conveyance direction and a rotary blade spirally provided along an outer periphery of the rotary shaft, conveys the developer in the conveyance direction by rotating the rotary blade around the rotary shaft, and includes a first section which is a section overlapping with the first path and in which the rotary blade has a specified conveyance characteristic in the conveyance direction, and a second section which is a section overlapping with the second path in the conveyance direction and in which the conveyance characteristic of the rotary blade is different from that in the first section.

Besides, according to another aspect of the invention, a development apparatus which supplies a developer to a development roller and conveys the developer while agitating it, includes a developer path including a first path and a second path whose height is lower than the first path and which is continuous with the first path in a conveyance direction of the developer, and conveyance means provided in the developer path, and including a first section which is a section overlapping with the first path and conveys the developer at a specified amount of conveyance in the conveyance direction and a second section which causes a height of an interface of the conveyed developer to become lower than the height of the second path.

Besides, according to another aspect of the invention, an image forming apparatus in which a developer is conveyed while being agitated, includes a developer path including a first path whose height is a specified height or higher and a second path whose height is lower than the specified height and which is continuous with the first path in a conveyance direction of the developer, a conveying member which is provided in the developer path, includes a rotary shaft and a rotary blade spirally provided along an outer periphery of the rotary shaft, conveys the developer in the conveyance direction along the rotary shaft by rotating the rotary blade around the rotary shaft, and includes a first section which is a section overlapping with the first path and in which a conveyance characteristic of the rotary blade is constant in the conveyance direction, and a second section which is a section overlapping with the second path in the conveyance direction and in which the conveyance characteristic of the rotary blade is different from that in the first section, and a development roller which uses the developer conveyed by the conveying member to develop an electrostatic latent image.

### DESCRIPTION OF THE DRAWINGS

FIG. 1 is a schematic structural view of an image forming apparatus including a development apparatus of a first embodiment of the invention.

FIG. 2 is a schematic structural perspective view of the development apparatus of the first embodiment of the invention.

FIG. 3 is a sectional view of a vicinity of a development roller of the development apparatus of the first embodiment on a surface vertical to a rotary shaft.

FIG. 4 is a sectional view of the development apparatus of the first embodiment taken along line Y1-Y1 of FIG. 3.

FIG. 5 is a sectional view of the development apparatus of the first embodiment taken along line Y2-Y2 of FIG. 3.

FIG. 6 is a sectional view of a development apparatus of a second embodiment taken along line Y1-Y1 of FIG. 3.

FIG. 7(a) is a sectional view of a development apparatus of a third embodiment taken along line Y1-Y1 of FIG. 3.

FIG. 7(b) is a schematic perspective view of a developer conveying member of the third embodiment.

FIG. 8 is a sectional view of a development apparatus of a fourth embodiment taken along line Y1-Y1 of FIG. 3.

FIG. 9 is a sectional view of the development apparatus of the fourth embodiment taken along line Y2-Y2 of FIG. 3.

FIG. 10 is a sectional view of a development apparatus of a fifth embodiment taken along line Y1-Y1 of FIG. 3.

### DESCRIPTION OF THE EMBODIMENTS

Hereinafter, embodiments of the invention will be described with reference to the drawings.

### First Embodiment

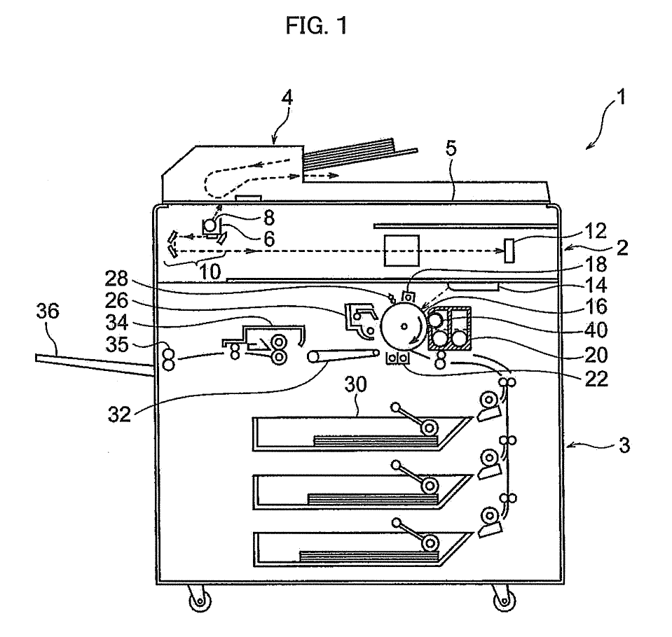

FIG. 1 is a schematic structural view of an image forming apparatus including a development apparatus of a first embodiment of the invention. As shown in FIG. 1, the image forming apparatus 1 includes an image reading unit 2 to read an image of a read object, and an image forming unit 3 to form an image.

The image reading unit 2 includes a transparent document mount table 5, a carriage 6, an exposure lamp 8 provided in the carriage 6, a reflecting mirror 10, and a CCD 12 (Charge Coupled Device) to capture reflected light and to convert image information of the light into an analog signal.

The image forming unit 3 includes a photoconductive body 16, and a laser unit 14 to form an electrostatic latent image on the photoconductive body 16, and further includes a charging apparatus 18, a development apparatus 20, a transfer apparatus 22, a cleaner 26 and a charge removal lamp 28 which are sequentially disposed around the photoconductive body 16.

When an original document placed on the document mount table 5 or an original document sent by an automatic document feeder 4 is irradiated with light from a lower part of the document mount table 5 by exposure means including the carriage 6 and the exposure lamp 8, the reflected light from the original document is guided by the reflecting mirror 10 and a reflected light image is projected on the CCD 12. The image information captured by the CCD 12 is outputted as an analog signal, and then is converted into a digital signal, and after an image processing is performed, it is transmitted to the laser unit 14 for image formation.

When the image formation is started, the charging apparatus 18 discharges electricity at a specified electric discharge position and supplies a specified electric charge to the outer peripheral surface of the rotating photoconductive body 16. The outer peripheral surface of the photoconductive body charged to have a uniform potential in the axial direction by the charging apparatus 18 is irradiated with a laser beam from the laser unit 14 in accordance with the transmitted image information. When an electrostatic latent image corresponding to the image information of the original document is formed and held on the outer peripheral surface of the photoconductive body by the irradiation of the laser beam, a developer (for example, toner) is supplied to the outer peripheral surface of the photoconductive body by the development apparatus 20, and the electrostatic latent image is converted into a toner image, that is, developed.

A development roller 40 is rotatably provided in the development apparatus 20, and the development roller 40 is disposed to be opposite to the photoconductive body 16 and is rotated, so that the toner is supplied to the photoconductive body 16. When the toner image is formed on the outer peripheral surface of the photoconductive body 16, the toner image is electrostatically transferred by the transfer apparatus 22 onto a sheet conveyed by the paper feed apparatus 30. Thereafter, the sheet is conveyed to the fixing apparatus 34 via a conveyance belt 32. The toner image transferred on the sheet adheres onto, that is, is fixed onto the sheet by the fixing apparatus 34. The sheet on which the toner image is fixed and the image formation is completed is discharged to a tray 36 by a paper discharge roller 35.

On the other hand, the toner not transferred but remaining on the photoconductive body 16 is removed by the cleaner 26 positioned downstream of the transfer apparatus 22 in the rotation direction of the photoconductive body 16, and the residual electric charge on the outer peripheral surface of the photoconductive body 16 is removed by the charge removal lamp 28.

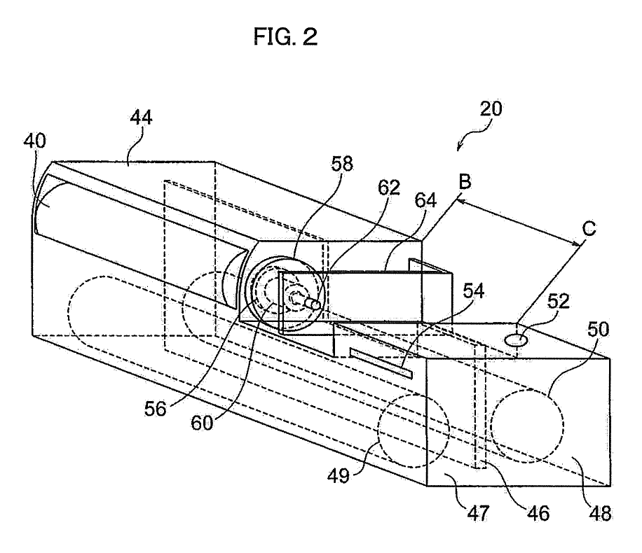

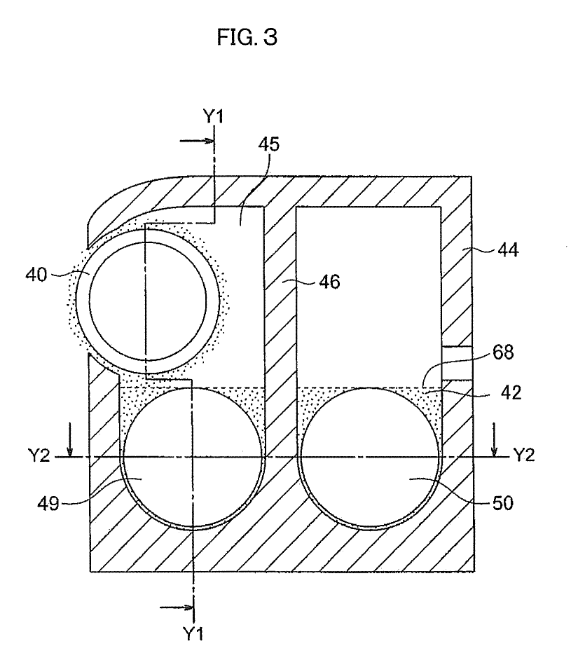

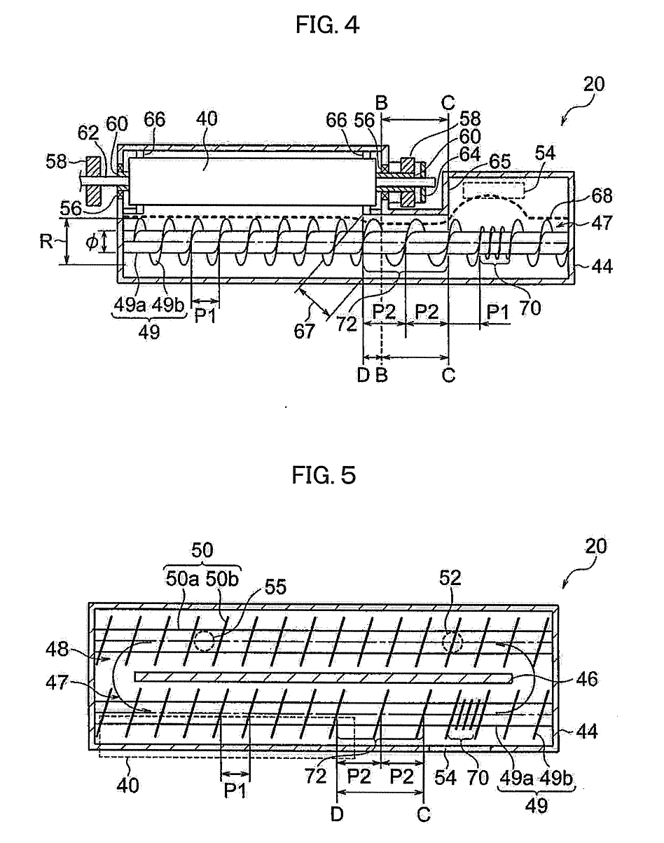

Next, the development apparatus 20 of the first embodiment of the invention will be described. FIG. 2 is a schematic structural perspective view of the development apparatus of the first embodiment of the invention, and FIG. 3 is a sectional view of a vicinity of the development roller 40 of the development apparatus of the first embodiment on the surface vertical to a rotary shaft. FIG. 4 and FIG. 5 are explanatory views of the inside of the development apparatus 20. Besides, FIG. 4 is a sectional view of the development apparatus of the first embodiment taken along line Y1-Y1 of FIG. 3. FIG. 5 is a sectional view of the development apparatus of the first embodiment taken along line Y2-Y2 of FIG. 3. Incidentally, in FIG. 4, the section of the development roller 40 is simplified, and the position of a development discharge port 54 is indicated by a dotted line. Besides, in FIG. 5, a rotary blade 49a of a first developer conveying member 49 and a rotary blade 50a of a second developer conveying member 50 are simplified, and the same applies to the following.

As shown in FIG. 2 to FIG. 5, the development apparatus 20 includes the development roller 40, a development container 44 to contain a developer 42, a first developer conveying member 49 (conveying means, conveying member), and a second developer conveying member 50. The development roller 40, the first developer conveying member 49 and the second developer conveying member 50 are respectively rotation driven by a motor. The development container 44 includes a development roller housing 45, a first developer conveying path 47 (developer path), and a second developer conveying path 48. The development roller housing 45 contains the development roller 40. The first developer conveying path 47 is the developer conveying path adjacent to the development roller housing 45 and extending in the axial direction of the development roller 40. The second developer conveying path 48 is the development conveying path disposed in parallel to the first developer conveying path 47. The first developer conveying path 47 and the second developer conveying path 48 communicate with each other at both end portions, and portions except both the end portions are partitioned by a partition wall 46.

Besides, a developer discharge port 54 (discharge means, discharge port) through which the developer 42 is discharged when the interface of the developer 42 is not lower than a certain height is disposed on the side surface of the first developer conveying path 47. Besides, a developer supply port 52 through which a new developer is supplied is disposed on an upper surface of the second developer conveying path 48, and a toner concentration sensor 55 to detect the toner concentration of the agitated and conveyed developer 42 is disposed at the bottom of the inside of the second developer conveying path 48.

The developer 42 is, for example, a two-component developer including a toner and a magnetic carrier.

The toner is made of a binding resin and a coloring agent as main ingredients. As the binding resin, polystyrene, styrene-acryl copolymer, polyester, epoxy resin, silicone resin, polyamide, paraffin wax or the like is used. As the coloring agent, an inorganic pigment or an organic pigment, or a combination of these is used. Specifically, carbon black is used, and further, benzidine yellow, mono azo dye or condensed azo dye is used for yellow in the case of a full-color toner, quinacridone or mono azo dye is used for magenta, and phthalocyanine blue or the like is used for cyan. Besides, a charge control agent, a cleaning auxiliary agent, a release accelerating agent, or a fluidity accelerating agent can be contained in the toner as the need arises.

As the carrier, a magnetic particle of ferrite, iron oxide or the like is used, or a core member made of these and coated with resin can be used. As the resin to be coated, a fluorine-containing resin, an acrylic resin, a silicone resin or the like is used, and these can be singly used or a combination of plural kinds can be used. Besides, a resin containing a magnetic powder can also be used as the carrier.

The development roller 40 is rotatably attached to the development container 44 through a bearing 56. A guide ring 58 to keep constant a distance between the photoconductive body 16 and the development roller 40 is attached to a development roller rotary shaft 60. The development roller 40 has a double structure, and includes a fixedly supported magnet roller and a rotatable cylindrical sleeve disposed on the outer periphery of the magnet roller. A magnet roller shaft 62 of the magnet roller is fixed by a fixing member 64. Besides, seal members 66 to prevent the developer from leaking to the bearing 56 or the outside of the development container 44 are attached to the vicinities of both ends of the development roller 40.

With respect to the development container 44, in a portion (B-C section in FIG. 4) where the guide ring 58 and the clamp such as the fixing member 64 are disposed, the first developer conveying path 47 and the second developer conveying path 48 include a protrusion 65 protruding more downward than the outer diameter of the development roller 40. The first developer conveying path 47 and the second developer conveying path 48 are narrower than the upstream conveying paths by the projection 65 in the B-C section, that is, the height from the bottom to the upper surface becomes low. Hereinafter, the portion where the developer conveying path is narrowed by the projection 65 is called a narrowed part 67. Besides, since the developer conveying path 47 is narrowed also by the seal member, as shown in FIG. 4, the narrowed part 67 in the first developer conveying path 47 is a D-C section including the B-C section where the first developer conveying path 47 is narrowed by the projection 65, and a D-B section where the first developer conveying path 47 is narrowed by the seal member 66. Incidentally, in this embodiment, a first path corresponds to a portion upstream of the narrowed part 67 in the first developer conveying path 47, a second path corresponds to the narrowed part 67 in the first developer conveying path 47, and a third path corresponds to a portion downstream of the narrowed part 67 in the first developer conveying path 47.

The first developer conveying member 49 is disposed in the first developer conveying path 47. The second developer conveying member 50 is disposed in the second developer conveying path 48. The first developer conveying member 49 includes a rotary shaft 49a extending in the axial direction of the development roller 40 and a rotary blade 49b formed spirally along the outer periphery of the rotary shaft 49a. Similarly, the second developer conveying member 50 includes a rotary shaft 50a extending in the axial direction of the development roller 40 and a rotary blade 50b formed spirally along the outer periphery of the rotary shaft 50a.

The first developer conveying member 49 and the second developer conveying member 50 are made of plastic such as ABS (ACRYLONITRILE BUTADIENE STYRENE) resin, what is obtained by further mixing glass fiber to reinforce the strength, or what is obtained by using stainless as the core.

The first developer conveying members 49 and the second developer conveying member 50 are rotated, so that the developer 42 is agitated and conveyed in the counterclockwise direction through a passage including the first developer conveying path 47 and the second developer conveying path 48 in FIG. 5, and is circulated in the development container 44. That is, in FIG. 5, the developer 42 is circulated in the development container 44 such that it is conveyed in the first developer conveying path 47 from the left to the right, it is conveyed from the first developer conveying path 47 to the second developer conveying path 48 at the right side of the partition plate 46, it is conveyed in the second developer conveying path 48 from the right to the left, and it is conveyed from the second developer conveying path 48 to the first developer conveying path 47 at the left side of the partition plate 46.

A developer interface 68 indicated by a broken line in FIG. 3 and FIG. 4 represents an interface of the developer 42. Incidentally, the developer interface 68 is basically the upper surface of the developer 42 contained in the development container 44.

The developer 42 is agitated in the development container 44 so that it is friction charged, and as shown in FIG. 3, chains are formed from the developer interface 68 by the magnetic force of a magnet roller in the development roller 40, and the developer is adsorbed onto the outer peripheral surface of the development roller 40. The developer 42 attracted by the magnetic force of the magneto roller forms a magnetic brush of chains along the magnetic line of force. The magnetic brush is made to rub against or to come close to the photoconductive drum 16, so that the development is performed.

Besides, in this embodiment, the developer 42 is supplied through the developer supply port 52, and the conveyed developer 42 is discharged by overflow from, for example, the developer discharge port 54 provided on the upper part of the wall surface of the developer container 44 downstream of the narrowed part 67 in the developer conveying direction. The discharged developer 42 is collected by an external developer collection container of the development container 44.

In order to stably perform the discharge of the developer 42, the developer discharge port 54 is disposed on the container wall surface higher than the normal height of the developer interface 68 conveyed at a pitch P1 of the developer conveying member at the upstream side of the narrowed part 67. Then, in order to discharge the developer 42 having a definite height or higher by overflow from the developer discharge port 54, the developer conveying member at the side where the developer discharge port 54 is disposed includes a developer raising unit 70 to decrease the conveyance amount of the developer 42. For example, the first developer conveying member 49 in FIG. 4 includes the developer raising unit 70 in the vicinity (position overlapping with the developer discharge port 54 in the developer conveyance direction) of the developer discharge port 54.

The developer raising unit 70 has such a shape that in the rotary shaft 49a and the rotary blade 49b constituting the first developer conveying member 49, for example, the blade height of the rotary blade 49b is made small, and the pitch thereof is narrowed.

Besides, the first developer conveying member 49 includes a developer interface lowering unit 72 whose conveyance characteristics are made different from those in the upstream region so that the developer interface 68 in the narrowed part 67 becomes lower than the upstream developer interface 68. The conveyance characteristics include a conveying speed (speed of the developer in the developer conveyance direction), and a conveyance capacity (capacity of the developer which can be conveyed by the rotary blade 49b per unit length in the developer conveyance direction). The developer interface lowering unit 72 includes one in which the conveying speed is made faster than that at the upstream side, and one in which the conveyance capacity is made larger than that at the upstream side.

As shown in FIG. 4, in the developer interface lowering unit 72 in this embodiment, the pitch of the rotary blade 49b in the narrowed part 67 is made P2. Here, P2 is larger than a pitch P1 of the rotary blade 49b at the upstream side (hereinafter referred to as a normal portion) of the narrowed part 67. As stated above, the pitch of the rotary blade 49b in the narrowed part 67 is made large, so that the conveying speed of the developer 42 in the developer interface lowering unit 72 (between C-D) is increased, and the height of the developer interface 68 is made low.

An example of the size of the first developer conveying member 49 in this embodiment will be described. An outer diameter R of the rotary blade 49b in the normal portion is 20 mm to 24 mm, the pitch P1 of the rotary blade 49b in the normal portion is 20 mm to 25 mm, and a shaft diameter φ of the rotary shaft 49a in the normal portion is 12 mm. In this case, P2 is set within a range of 1.1 to 2.5 times larger than P1, so that the height of the developer interface 68 is lowered, and the developer 42 can be stably conveyed. Besides, when P2 is 1.5 times larger than P1, especially an excellent result is obtained.

Besides, in this embodiment, the pitch of the rotary blade 49b between the developer interface lowering unit 72 and the developer raising unit 70 is P1.

According to the development apparatus 20 of the embodiment, the developer interface lowering unit 72 in which the pitch of the rotary blade 49b of the first developer conveying member 49 is made larger than that in the normal portion is provided in the portion of the narrowed part 67, so that the conveying speed of the developer 42 in the narrowed part 67 is increased, and the developer interface 68 in the narrowed part 67 is made lower than that in the normal portion. As a result, it is possible to prevent that the developer interface 68 comes in contact with the inlet (B side end of the protrusion 65 or D side end of the seal member 66) of the narrowed part 67 and the developer 42 is clogged, and the stable agitation and conveyance can be performed. Accordingly, it is possible to prevent uneven density due to the leakage of the developer 42 to the developer roller 40 side.

Besides, since the developer interface 68 in the narrowed part 67 is made low by the developer interface lowering unit 72, it is possible to prevent that the skirt of the rising of the developer interface 68 by the developer raising unit 70 comes in contact with the outlet (C side end of the protrusion 65) of the narrowed part 67, and the developer 42 is clogged in the narrowed part 67 or the inlet of the narrowed part 67. Besides, it is possible to prevent the developer 42 compressed in the narrowed part 67 from being blown off, and the sway of the rising of the developer interface 68 at the downstream side can be prevented, and accordingly, the stable discharge can be performed from the developer discharge port 54.

Incidentally, the developer interface lowering unit 72 may not be provided in the whole section in the narrowed part 67 in the first developer conveying member 49. For example, the most upstream part of the developer interface lowering unit 72 may be positioned upstream of the inlet (B side end of the protrusion 65 or D side end of the seal member 66) of the narrowed part 67. Besides, the most downstream part of the developer interface lowering unit 72 may be positioned upstream of the outlet (C side end of the protrusion 65) of the narrowed part 67.

Incidentally, although the degree of lowering of the developer interface 68 by the developer interface lowering unit 72 depends on the amount of the developer 42 in the development container 44, it is desirable that at least the developer interface 68 at the time of conveyance is lower than the protrusion 65 of the narrowed part 67.

### Second Embodiment

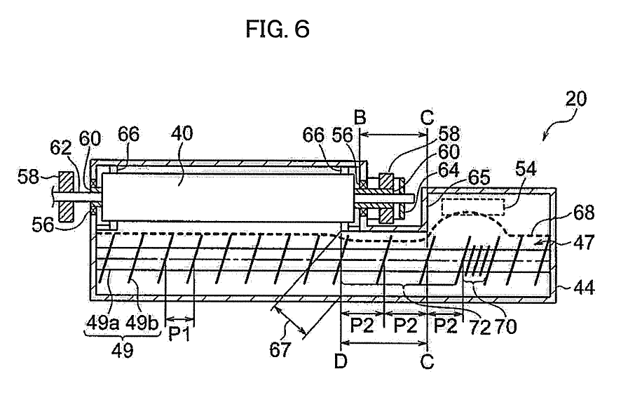

Hereinafter, the same portions as those of the development apparatus of the first embodiment are denoted by the same reference numerals, and only feature portions of this embodiment will be described. FIG. 6 is a sectional view of the development apparatus of the second embodiment taken along line Y1-Y1 of FIG. 3.

In the developer conveying member 49 of the first embodiment shown in FIG. 4 and FIG. 5, the region where the pitch of the rotary blade 49b is P1 is provided between the developer interface lowering unit 72 and the developer raising unit 70, whereas in this embodiment, as shown in FIG. 6, a developer interface lowering unit 72 is extended to the downstream region, and the developer interface lowering unit 72 and a developer raising unit 70 are continuously provided.

Incidentally, in this embodiment, although the developer interface lowering unit 72 and the developer raising unit 70 are continuous with each other, no limitation is made to this, and even if not continuous with the developer raising unit 70, the developer interface lowering unit 72 may be formed downstream of the exit (C side end of a protrusion 65) of the narrowed part 67.

According to this embodiment, the same effect as that of the first embodiment can be obtained, and further, since the developer interface lowering unit 72 of the first developer conveying member 49 is extended to be provided not only in the narrowed part 67 but also in the further downstream region, it is possible to more certainly prevent the skirt of the rising of the developer interface 68 by the developer raising unit 70 from blocking the vicinity of the narrowed part 67.

### Third Embodiment

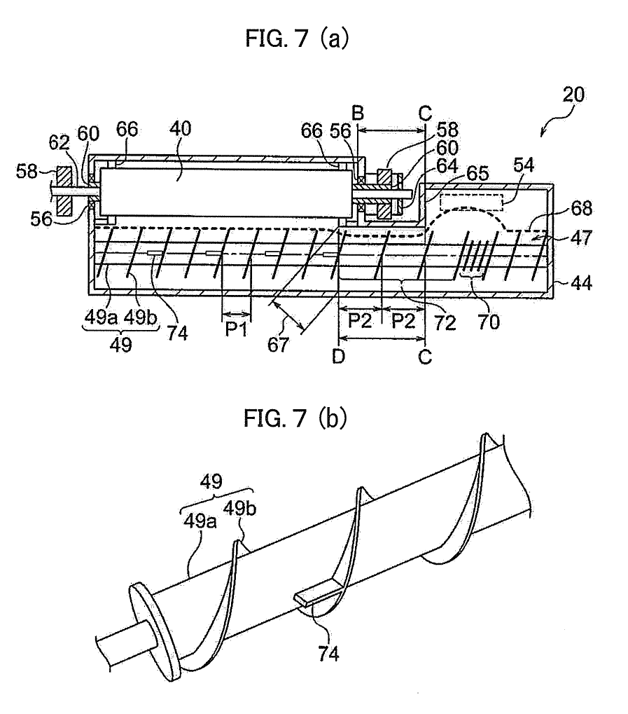

Hereinafter, the same portions as those of the development apparatus of the first embodiment are denoted by the same reference numerals, and only feature portions of this embodiment will be described. FIG. 7 is a structural view of a development apparatus of a third embodiment. FIG. 7(a) is a sectional view of the development apparatus of the third embodiment taken along line Y1-Y1 of FIG. 3. FIG. 7(b) is a schematic perspective view of a developer conveying member of the third embodiment.

As shown in FIG. 7(a) and FIG. 7(b), lateral plates 74 (plates) are provided at regular intervals on a rotary blade 49b of a first developer conveying member 49 at the upstream side of a narrowed part 67. Incidentally, the lateral plate 74 is not provided on the rotary blade 49b of the first developer conveying member 49 in the narrowed part 67 and at the downstream side of the narrowed part 67. The developer 42 is agitated by the rotary blade 49b and the lateral plates 74

According to this embodiment, in addition to the same effect as that of the first embodiment, the agitation power of the developer 42 can be increased at the upstream side of the narrowed part 67.

### Fourth Embodiment

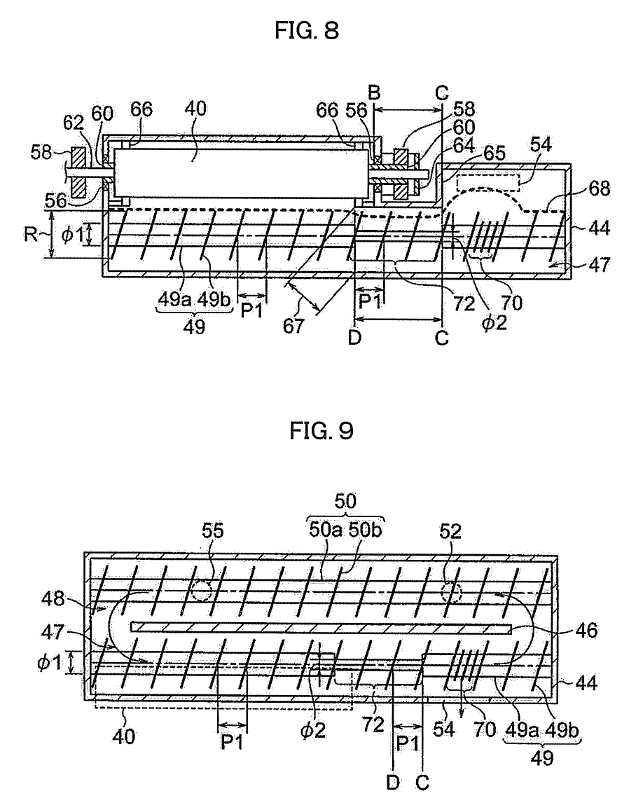

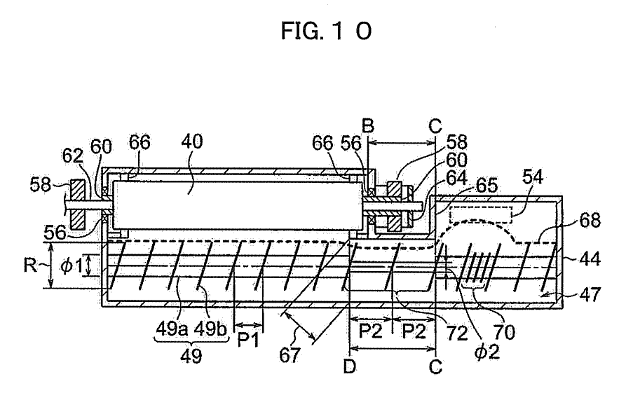

Hereinafter, the same portions as those of the development apparatus of the first embodiment are denoted by the same reference numerals, and only feature portions of this embodiment will be described. FIG. 8 is a sectional view of a development apparatus of a fourth embodiment taken along line Y1-Y1 of FIG. 3. FIG. 9 is a sectional view of the development apparatus of the fourth embodiment taken along line Y2-Y2 of FIG. 3.

As shown in FIG. 8 and FIG. 9, when a shaft diameter of a rotary shaft 49a at an upstream side (normal portion) of a narrowed part 67 is φ1, and a shaft diameter of the rotary shaft 49a in a developer interface lowering unit 72 (in the narrowed part 67) is φ2, φ2 is smaller than φ1. The rotary shaft 49a in the narrowed part 67 is made thinner than the rotary shaft 49a in the normal portion, so that the conveyance capacity in the narrowed part 67 is increased more than that in the normal portion, and the height of a developer interface 68 in the narrowed part 67 can be made lower than that in the normal portion.

Besides, an outer diameter and a pitch of a rotary blade 49b of the developer interface lowering unit 72 are respectively equal to an outer diameter R and a pitch P1 in the normal portion.

An example of the size of the first developer conveying member 49 in this embodiment will be described. The diameter R of the rotary blade 49b in the normal portion is set to 20 mm to 24 mm, the pitch P1 of the rotary blade 49b in the normal portion is set to 20 mm to 25 mm, and the shaft diameter φ1 of the rotary shaft 49a in the normal portion is set to 12 mm. The rotary shaft 49a is made of ABS resin. In this case, when φ2 is set within a range of 2/6 to 5/6 times larger than φ1, the height of the developer interface 68 is lowered, and the developer 42 can be stably conveyed. In this embodiment, the shaft diameter φ2 of the rotary shaft 49a of the developer interface lowering unit 72 is set to 8 mm. Incidentally, with respect to φ2, the required strength has only to be kept by the material of the first developer conveying member 49 and the length in the axial direction, and when a material having strength is used, φ2 can be made smaller.

Besides, similarly to the second embodiment, the developer interface lowering unit 72 may be formed also on the downstream side of the exit (C side end of a protrusion 65) of the narrowed part 67.

According to this embodiment, the developer interface lowering unit 72 in which the shaft diameter of the rotary shaft 49a of the first developer conveying member 49 is smaller than that in the normal portion is provided in the vicinity of the narrowed part 67, so that the conveyance capacity of the developer 42 in the narrowed part 67 can be increased more than that in the normal portion. As a result, the developer interface 68 in the narrowed part 67 can be made lower than that in the normal portion, and the same effect as that of the first embodiment can be obtained.

### Fifth Embodiment

Hereinafter, the same portions as those of the development apparatus of the first embodiment are denoted by the same reference numerals, and only feature portions of this embodiment will be described. FIG. 10 is a sectional view of a development apparatus of a fifth embodiment taken along line Y1-Y1 of FIG. 3.

Although the pitch of the rotary blade 49b of the developer interface lowering unit 72 of the fourth embodiment is P1 equal to the pitch in the normal portion, in this embodiment, as shown in FIG. 10, a shaft diameter φ2 of a rotary shaft 49a in a developer lowering unit 72 is smaller than a shaft diameter φ1 of the rotary shaft 49a in a normal portion, and further, a pitch P2 of a rotary blade 49b in the developer interface lowering unit 72 is larger than a pitch P1 of the rotary blade 49b in the normal portion.

Besides, similarly to the second embodiment, the developer interface lowering unit 72 may be formed also on the downstream side of the exit (C side end of a protrusion 65) of the narrowed part 67.

According to this embodiment, the developer interface lowering unit 72 in which the shaft diameter of the rotary shaft 49a of the first developer conveying member 49 is smaller than that in the normal portion and the pitch of the rotary blade 49b is larger than that in the normal portion is provided in the vicinity of the narrowed part 67, so that the conveyance capacity of the developer 42 and the conveyance speed thereof in the narrowed part 67 can be increased more than those in the normal portion. As a result, the developer interface 68 in the narrowed part 67 can be made lower than that in the normal portion, and the same effect as that of the first embodiment can be obtained.

Incidentally, the invention is not limited to the example as in the embodiment in which the developer interface lowering unit 72 is provided in the first developer conveying member 49 in the first developer conveying path 47 in which the development roller 40 is contained. For example, in the case where the second developer conveying path 48 includes a narrowed part similar to the first developer conveying path 47, the developer interface lowering unit 72 to lower the developer interface 68 may be provided in the vicinity of the narrowed part in the second developer conveying member 50. By this, it is possible to avoid the problem that the developer 42 is clogged in the narrowed part of the second developer conveying path 48, and the amount of the developer conveyed toward the downstream side is reduced, and it becomes possible to perform stable developer conveyance.

Besides, the place where the developer discharge port 54 is provided is not limited to the first developer conveying path 47, and it may be provided in the second developer conveying path 48. Especially, in the case where the second developer conveying path 48 has a narrowed part, the developer discharge port 54 is provided downstream of and in the vicinity of the narrowed part, and the developer interface 68 is raised in the vicinity of the developer discharge port 54, the developer interface lowering unit 72 to lower the developer interface 68 is provided in the vicinity of the narrowed part in the second developer conveying member 50, so that it is possible to prevent that the skirt of the rising of the developer interface 68 reaches the narrowed part and the developer 42 is clogged in the narrowed part. Further, it is possible to prevent the developer 42 compressed in the narrowed part of the second developer conveying path 48 from being blown off, and the sway of the rising of the developer interface 68 can be prevented, and accordingly, the developer 42 can be stably discharged from the developer discharge port 54. On the other hand, in the case where the second developer conveying path 48 includes the narrowed part, the developer discharge port 54 is provided upstream of and in the vicinity of the narrowed part, and the developer 68 is raised in the vicinity of the developer discharge port 54, it is possible to prevent that the skirt of the rising of the developer interface 68 reaches the narrowed part and the developer 42 is clogged in the narrowed part, and it becomes possible to stably convey the developer 42.

Besides, in the embodiment, although the height of the developer interface is changed by changing the outer diameter of the rotary blade and the shaft diameter of the rotary shaft for each section of the developer conveying member, the height of the developer interface may be changed by changing the thickness of the rotary blade or the surface roughness of the rotary blade.

As described above, the invention is not limited to the above embodiments, but may be variously modified and carried out within the scope not departing from the gist, and the embodiments may be suitably combined and carried out.

As described above in detail, according to the invention, it is possible to provide a development apparatus which enables stable agitation and discharge of a developer from a developer discharge port and an image forming apparatus including this development apparatus.

What is claimed is:

1. A development apparatus which supplies a developer to a development roller and conveys the developer while agitating it, comprising:
a developer path including a first path and a second path whose height is lower than the first path and which is continuous with the first path in a conveyance direction of the developer; and
a conveying member which is provided in the developer path, includes a rotary shaft along the conveyance direction and a rotary blade spirally provided along an outer periphery of the rotary shaft, conveys the developer in the conveyance direction by rotating the rotary blade around the rotary shaft, and includes a first section which is a section overlapping with the first path and in which the rotary blade has a specified conveyance characteristic in the conveyance direction, and a second section which is a section overlapping with the second path in the conveyance direction and in which the conveyance characteristic of the rotary blade is different from that in the first section.

2. The development apparatus according to claim 1, wherein the second section overlaps with an inlet of the second path in the conveyance direction.

3. The development apparatus according to claim 2, wherein the second section further overlaps with an exit of the second path in the conveyance direction.

4. The development apparatus according to claim 1, wherein a pitch of the rotary blade in the second section is larger than the pitch of the rotary blade in the first section.

5. The development apparatus according to claim 1, wherein a shaft diameter of the rotary shaft in the second section is smaller than the shaft diameter of the rotary shaft in the first section.

6. The development apparatus according to claim 5, wherein a pitch of the rotary blade in the second section is larger than the pitch of the rotary blade in the first section.

7. The development apparatus according to claim 1, wherein the developer path further includes a third path continuous with the second path in the conveyance direction and having a path height higher than that of the second path,
the conveying member further includes a third section which is a downstream section in the conveyance direction with respect to the second section and in which the conveyance characteristic of the rotary blade is different from that in the first section and in the second section, and
the development apparatus further comprises a discharge port for discharging the developer whose interface has a height of a specified value or more from the developer path.

8. The development apparatus according to claim 7, wherein the discharge port is provided in the third path, and is provided in a section where a position in the conveyance direction overlaps with the third section or in a section downstream of the third section in the conveyance direction.

9. The development apparatus according to claim 1, wherein in the first section, at least one plate to increase agitation power is provided on the rotary blade.

10. A development apparatus which supplies a developer to a development roller and conveys the developer while agitating it, comprising:
a developer path including a first path and a second path whose height is lower than the first path and which is continuous with the first path in a conveyance direction of the developer; and
conveyance means provided in the developer path, and including a first section which is a section overlapping with the first path and in which the developer is conveyed at a specified amount of conveyance in the conveyance direction, and a second section which causes a height of an interface of the conveyed developer to become lower than the height of the second path.

11. The development apparatus according to claim 10, wherein in the second section, the developer is conveyed in the conveyance direction at a conveyance speed higher than the conveyance speed in the first section, and the height of the interface of the developer is lowered.

12. The development apparatus according to claim 10, wherein the second section has a conveyance capacity larger than a conveyance capacity in the first section and the height of the interface of the developer is lowered.

13. The development apparatus according to claim 10, wherein the second section overlaps with the second path in the conveyance direction.

14. The development apparatus according to claim 10, wherein
the developer path further includes a third path continuous with the second path in the conveyance direction and having a path height higher than that of the second path,
the conveyance means further includes a third section in which the interface of the developer is locally raised at a downstream side of the second section in the conveyance direction, and
the development apparatus further comprises discharge means for discharging the developer whose interface is raised in the third section from the developer path.

15. The development apparatus according to claim 14, wherein the discharge means is provided in the third passage, and is provided in a section where a position in the conveyance direction overlaps with the third section or in a section downstream of the third section in the conveyance direction.

16. The development apparatus according to claim 10, wherein the conveyance means includes a rotary shaft and a rotary blade spirally provided along an outer periphery of the rotary shaft, and the rotary blade rotates around the rotary shaft to convey the developer in the conveyance direction along the rotary shaft.

17. The development apparatus according to claim 16, wherein in the first section, at least one plate to increase agitation power is provided on the rotary blade.

18. An image forming apparatus in which a developer is conveyed while being agitated, comprising:
a developer path including a first path whose height is a specified height or higher and a second path whose height is lower than the specified height and which is continuous with the first path in a conveyance direction of the developer;
a conveying member which is provided in the developer path, includes a rotary shaft and a rotary blade spirally provided along an outer periphery of the rotary shaft, conveys the developer in the conveyance direction along the rotary shaft by rotating the rotary blade around the rotary shaft, and includes a first section which is a section overlapping with the first path and in which a conveyance characteristic of the rotary blade is constant in the conveyance direction, and a second section which is a section overlapping with the second path in the conveyance direction and in which the conveyance characteristic of the rotary blade is different from that in the first section; and
a development roller which uses the developer conveyed by the conveying member to develop an electrostatic latent image.
